(19) United States
(12) Patent Application Publication
(10) Pub. No.: US 2008/0120604 A1
(43) Pub. Date: May 22, 2008

(54) Methods, Systems, And Computer Program Products For Providing Program Runtime Data Validation

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/561,438

(22) Filed: Nov. 20, 2006

(51) Int. Cl. G06F 11/36

(52) U.S. Cl. 717/128

(57) ABSTRACT

A method and system are described for providing program runtime data validation. A memory location of an addressable entity is associated with a runtime constraint for the addressable entity. The addressable entity is included in an executable program component generated from source code written in a processor-independent programming language. The memory location is monitored during runtime and it is determined whether access to the memory location by a machine code instruction of an executable program component violates the runtime constraint using validation information associated with the memory location. The validation information is not included in the executable program component and the determining is not performed by the executable program component.

### BACKGROUND

It is well known by those skilled in the art of software development that a large portion of executable program code in any executable program component is typically devoted to error detection and error handling. Much of this is devoted to validating input parameters to subroutine, method, and function calls; validating output, and to some extent checking intermediate results. The use of this error detection code is often essential for debugging the executable program component. The error detection code is often left in the source code for use by those providing software support, for lack of time to remove it, or for fear that its removal will introduce new bugs to code that is already running. Currently, this data validation code has to be added to each executable program component, thus duplicating code and resulting in requiring more secondary memory, processor memory, and processor time to achieve the same functionality.

An even worse problem results when programmers don't bother to validate data processed in an executable program component. This leads to bug-laden code that often requires a great deal of time to test and is expensive to support upon release for general use.

Current source code debuggers are typically language specific, thus requiring a different debugger for each executable program component associated with a different language. Source code debuggers also require a language compiler to insert code into a monitored executable program component to enable the debugger to match machine instructions and data locations to source code instructions and data declarations. The memory requirement for source-code-debugger-compatible executable program components is thus significantly increased and program performance is typically greatly degraded by the extra instructions. Perhaps most significantly, executable code is typically distributed without source code, thus the use of a source code debugger by users without the associated source code provides little, if any, value.

Accordingly, there exists a need for methods, systems, and computer program products for providing program runtime data validation based on validation information where the validation information is not included in the executable program component.

### SUMMARY

In one aspect of the subject matter disclosed herein, a method and system are described for providing program runtime data validation. A memory location of an addressable entity is associated with a runtime constraint for the addressable entity. The addressable entity is included in an executable program component generated from source code written in a processor-independent programming language. The memory location is monitored during runtime and it is determined whether access to the memory location by a machine code instruction of an executable program component violates the runtime constraint using validation information associated with the memory location. The validation information is not included in the executable program component and the determining is not performed by the executable program component.

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any means that can contain, store, communicate, propagate, or transport instructions for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, a portable compact disc read-only memory (CDROM), a portable digital video disc (DVD), a wired network connection and associated transmission medium, such as an ETHERNET transmission system, and/or a wireless network connection and associated transmission medium, such as an IEEE 802.11(a), (b), or (g) or a BLUETOOTH transmission system, a wide-area network (WAN), a local-area network (LAN), the Internet, and/or an intranet.

Thus, the subject matter described herein can be embodied in many different forms, and all such forms are contemplated to be within the scope of what is claimed.

The term “processor independent programming language” as used in this document refers to a programming language from which a plurality of machine code representations may be generated for a single source written using the programming language. That is, a machine code representation of the source may be generated that is executable on a processor from a particular processor family, such as the Intel® x86 processor family, and a machine code representation may be generated that is executable on a processor of a second processor family such as the PowerPC® processor family. For the purposes of this document, processors will be considered to be in the same family if they are able to process a machine representation of a source written in a common portion of an assembly language. Thus, an 80286 processor and an 80586 processor are in the same family, since both are able to run a machine code representation executable on the 80286 processor.

As used herein, the terms “program”, “application”, “executable”, or “program executable component” refer to any data representation that may be translated into a set of machine code instructions and associated program data. Thus, a program or executable may include an application, a shared or non-shared library, and a system command. Program representations other than machine code include object code, byte code, and source code.

As used herein, the term “object code” includes a set of instructions and/or data elements that are either prepared for linking prior to loading, are loadable into an execution environment, or are loaded into an execution environment. When in an execution environment, object code may be linked, or may have one or more unresolved references. The context in which this term is used will make clear that state of the object code when it is relevant. This definition includes machine code and virtual machine code including Java® TM byte code.

As used herein, the term “addressable entity” is any data that may be stored in a memory location or an execution environment and located/addressed using an identifier associated with the memory location. Addressable entities may be a part of a computer program or they may be data that exists apart from a program executable such as a file or a portion of a file. A program addressable entity is a portion of a program specifiable in a source code language, which is addressable within a compatible execution environment. Examples of program addressable entities include variables including structures, constants including structured constants, functions, subroutines, methods, classes, anonymous scoped instruction sets, and individual instructions, which may be labeled. Strictly, the addressable entity contains a value or an instruction, but it is not the value or the instruction. In some places, this document will use addressable entity in a manner that refers to the content or value of the entity. In these cases, the context will clearly indicate the intended meaning. Program addressable entities may have a number of corresponding formats. These formats include source code, object code, and any intermediate formats used by an interpreter, compiler, linker, loader, or equivalent tool. Thus, terms such as addressable source code entity may be used in cases where the format is relevant and required by the context for clarity. When the context is not clear and the format matters, the term “addressable entity” is to be interpreted as “addressable object code entity”.

As used herein, the term “validation information” with respect to data associated with an access to a memory location of an addressable entity refers to information that defines a condition that the data must meet in order for the access to be considered valid. For example, in “C” source code, exemplary validation information may be created using an “assert” statement such as:

assert(x>10);

The assert statement above has a corresponding machine code representation generated by associated development tools such as a compiler, where the generated machine code checks the value of the addressable entity ‘x’ at a location in the machine code corresponding to the location of the assert statement in the source code. If the value of ‘x’ is greater than ten, execution is allowed to continue. If the value is less than or equal to ten, machine code generated from the source generates an error message and execution is halted. In fact, in a programming language, any source code that checks a condition using an attribute of an addressable entity for the purpose of error checking constitutes validation information. When an error or violation is detected, the source code provided that is associated with a violation is referred to as “error handling information” or “exception handling information”.

Other examples of validation information, not related to source code written in a programming language include extensible markup language (XML) schema and document type definition (DTD) schema specifications used to determine whether XML documents conform to a particular set of rules specified by the schema or validation information. In support of programming languages, type checking performed by a compiler uses validation information specified by the language included in the compiler, and is typically language specific. In a structured query language (SQL) database, SQL commands associated with a table support information that places constraints on the structure of the table including, for example, the data type of each column, the initial value of a column in a record, a relationship between a column in a first table and a column in a second table, a value in a column, a size of a column, and a size of a table, in another non-programming language example of validation information.

As used herein, the term “address space” or “identifier space” refers to a set of addresses or identifiers that may be associated with memory or memory locations.

As used herein, the term “structured data memory system” (SDSS) is defined within the context of embodiments using the systems and methods described in U.S. patent application Ser. Nos. 11/428,273, 11/428,280, and 11/428,338, entitled “Methods, Systems, And Computer Program Products For Providing A Program Execution Environment,” “Methods, Systems, And Computer Program Products For Generating And Using Object Modules,” and “Methods, Systems, and Computer Program Products for Providing Access to Addressable Entities Using a Non-Sequential Virtual Address Space,” respectively, all of which are incorporated by reference herein.

As used herein, the term “memory” refers to either virtual or physical memory, or both, accessible via a processor through a processor supported address space. More broadly, the term refers to the memory associated with the address space of a runtime environment, also known as an execution environment, which includes virtual execution environments.

As used herein, the term “storage” refers to persistent, secondary storage such as storage provided by a hard drive.

As used herein, the term “access” as used with respect to a memory location includes the operations of reading from and writing to a memory location. Operations that read to and/or write from a memory location include loading and storing data into and from, respectively, a processor register, copying content from a first memory location to a second memory location, deleting an association between an addressable entity and a memory location, and creating a association between an addressable entity and a memory location. Processing the contents of a memory location involves reading an instruction from a memory location, so an execution access is viewed as a type of read access.

As used herein, the term “code block” refers to any set of executable instructions that are addressable as an executable unit. Examples of code blocks include functions, subroutines, methods associated with classes, labeled instructions which may be the target of “jump” or “goto” instructions, and anonymous code blocks such as a while loop.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a block diagram illustrating a system that includes components for providing runtime data validation according to an embodiment of the subject matter described herein;

FIG. 2 is a flowchart illustrating an exemplary method for providing data validation for data associated with an access to a memory location of an addressable entity in an executable program component;

FIG. 3 is a block diagram illustrating an exemplary system for monitoring access to the memory location of an addressable entity according to one embodiment;

FIG. 4 is a block diagram illustrating an exemplary system for monitoring access to the memory location of an addressable entity according to another embodiment;

FIG. 5 is a flow chart illustrating another exemplary method for providing data validation for data associated with an access to a memory location of an addressable entity in an executable program component;

FIG. 6 is a block diagram illustrating an exemplary system for monitoring access to the memory location of an addressable entity according to another embodiment; and

FIG. 7 is a block diagram illustrating an exemplary system for monitoring access to the memory location of an addressable entity according to another embodiment.

### DETAILED DESCRIPTION

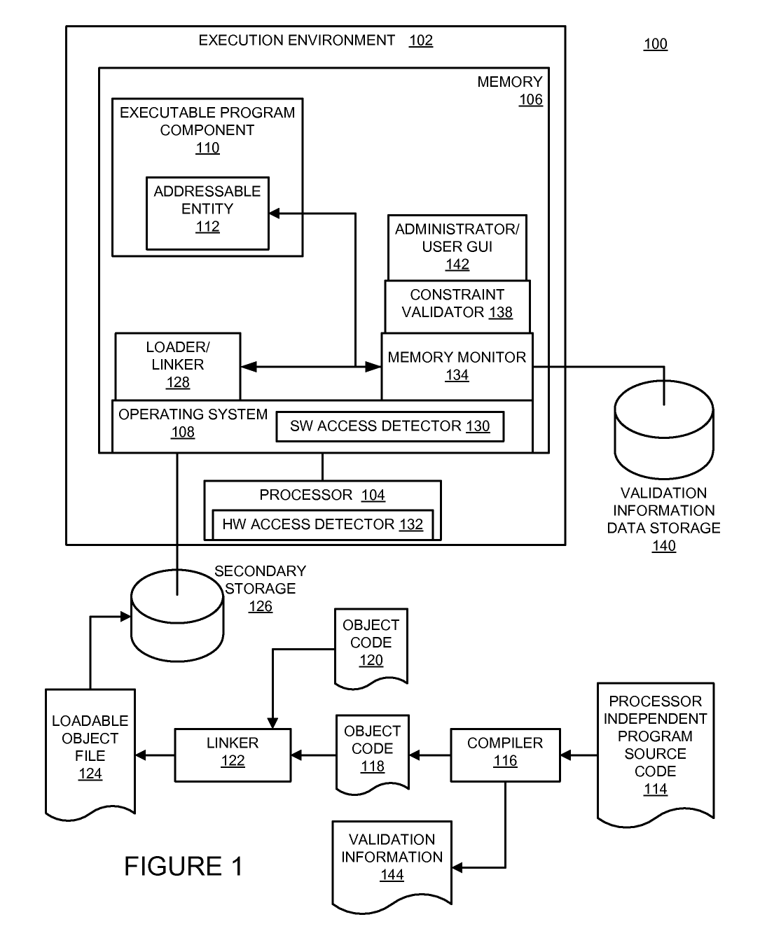

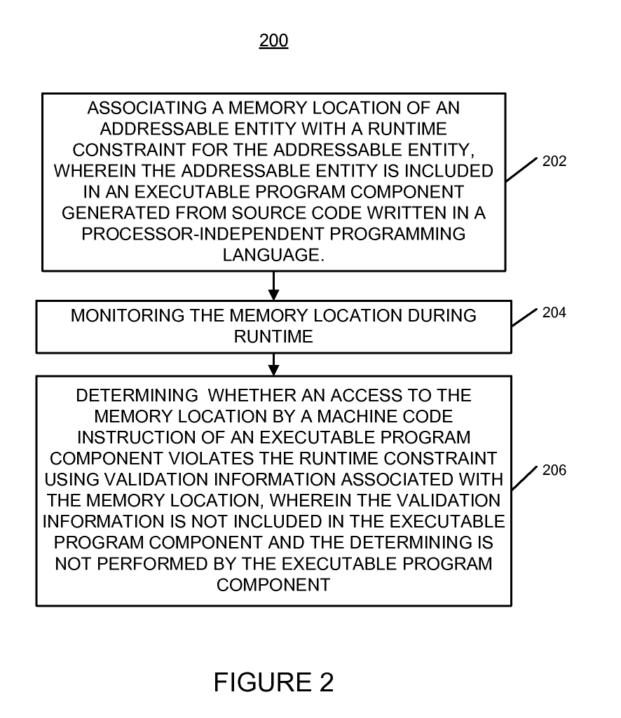

FIG. 1 is a block diagram illustrating a system 100 that includes components for providing runtime data validation according to an embodiment of the subject matter described herein. The components for providing runtime data validation in system 100 operate in conjunction with components for processing object code, such as an execution environment 102 that includes a processor 104, a memory 106, and an operating system 108. Memory 106 includes, stored therein, an executable program component 110 that includes an addressable entity 112. The operation of system 100 will be described in conjunction with FIG. 2.

FIG. 2 is a flowchart 200 illustrating an exemplary method for providing data validation for data associated with an access to a memory location of an addressable entity in an executable program component. The method can be carried out using the exemplary system 100 shown in FIG. 1, portions of which are referenced below for illustration purposes.

The executable program component 110, including the addressable entity 112, can be generated from a processor independent programming language using development tools. The developmental tools process representations of computer program source code by performing functions including, for example, compiling, linking, loading, and interpreting. For example, executable program component 110 is a representation of source code 114, which is written in a processor-independent programming language such as Java, C, C++, Basic, Perl, or Ruby. As such, source code 114 may be used to generate an executable representation capable of being run in an execution environment supported by a processor from a family other than the family of processor 104. If, for example, processor-independent program source code 114 is written in ‘C’, then executable program component 110 can be generated through a process of compiling source 114 using a compiler 116 and resulting in an object code representation 118. Object code representation 118 can be linked, if needed with another object code representation 120 generated from another source (not shown) using a linker 122, thereby producing a loadable object file 124 that can be stored in a secondary storage 126 configured for persistently storing loadable objects.

Returning to FIG. 2, in block 202, a memory location of the addressable entity 112 is associated with a runtime constraint for the addressable entity. For example, in system 100, the executable program component 110 is loaded into a location in memory 106 and can be thereby associated with the memory location. The system 100 includes means for associating a memory location of an addressable entity with a runtime constraint for the addressable entity. For example, a loader component 128 in system 100 is configured for associating a memory location of the addressable entity 112 with a runtime constraint for the addressable entity 112. The addressable entity 112 is included in the executable program component 110 generated from source code 114 written in a processor-independent programming language. In this example, the loader component 128 for loading the executable program component 110 into a memory location is a loading component of the loader/linker 128. The loader 128 loads the loadable object file 124 stored in the secondary storage 126 into the memory 106. During the process of loading, the loader 128 reserves memory locations which may be associated with addressable entities of the executable program component 110 as each addressable entity is instantiated, or stores values associated with instantiated addressable entities in the memory location of each addressable entity as provided by the loader 128 at load-time. If executable program component 110 contains any unresolved references to addressable entities external to executable program component 110, a load-time or runtime linking process can be performed by a linking component of loader/linker 128 for resolving the unresolved references to enable executable program component 110 to be processed by processor 104.

In block 204 of FIG. 2, the memory location is monitored during runtime. The system 100 includes means for monitoring the memory location during runtime. For example, in FIG. 1, a memory monitor component 134 is configured for monitoring the memory location for the addressable entity 112 during runtime. The memory monitor 134 is preferably independent of the executable program component 110 being monitored and the source 114 from which it is generated. The monitoring component 134 is independent in the sense that it does not require the source code 114 in order to perform its monitoring function. The monitoring component 134 also preferably does not need to use program code inserted specifically into the executable program component 110 to enable monitoring of the addressable entity 112 whose memory location is being monitored.

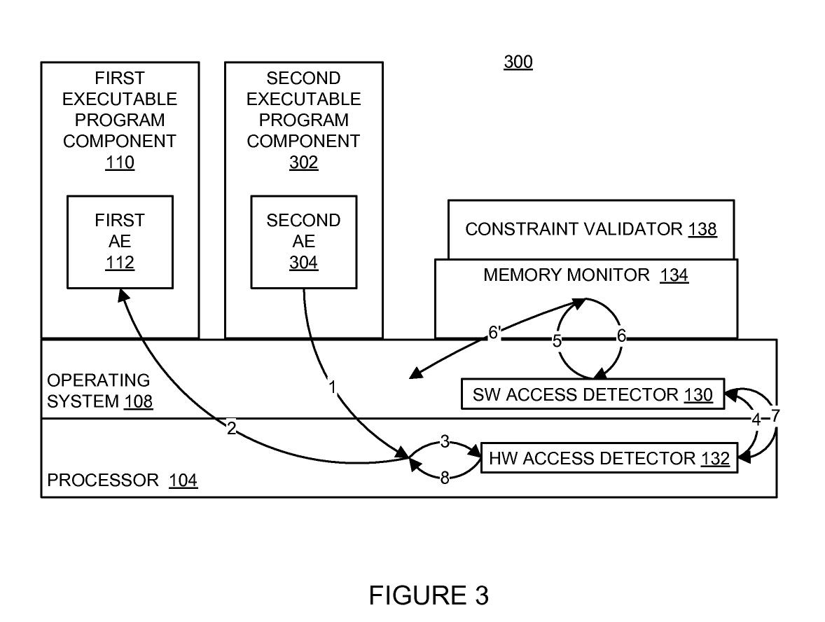

An exemplary system 300 for monitoring access to the memory location of addressable entity 112 is illustrated in FIG. 3, which includes components of system 100. The memory monitor 134 can include at least one of a software access detector 130 and a hardware access detector 132. In the examples illustrated in FIGS. 1 and 3, monitoring subsystem 300 includes both a software access detector component 130 and a hardware access detector component 132. For example, an access to the memory location of the monitored addressable entity 112, referred to as the first addressable entity in FIG. 3, can be attempted in the system 300 as a result of processor 104 processing an instruction of a second addressable entity 304 of a second executable program component 302 as illustrated by messages 1 and 2 in FIG. 3. A message may be in the form of a call, interrupt, signal, or data passed via a pipe, message queue, or network transmission, for example. The processing of the instruction within processor 104 causes, as illustrated by message 3, hardware access detector 132 to generate an interrupt illustrated by message 4. Hardware access detector 132 may do this for all accesses or may maintain monitoring information that it uses to determine whether an accessed memory location is monitored, thus causing message 4. In the current example, software access detector 130 is registered as an interrupt handler for the generated interrupt and, upon receiving message 4, is invoked to handle the interrupt. Software access detector 130 passes control and access information received via the interrupt from hardware access detector 132 to the memory monitor 134, as illustrated by message 5. In an alternate embodiment, hardware access detector 132 may signal software access detector 130 without interrupting the processing of processor 104. Software access detector 130 and monitor 134 may be associated with a second processor (not shown) and may thus operate in parallel to executable program component 110. Through the use of instruction look-ahead, memory monitor 134 may perform at least a portion of the monitoring of the memory location of addressable entity 112 prior to an actual access. Access detection and/or monitoring may be performed prior to an access, after an access, or during an access, as is the case in the current example.

The hardware access detector 132 and/or the software access detector 130, may determine that a detected access is an access of a monitored memory location. The software access detector is shown as included in operating system 108, but may be a separate application, a supporting subsystem of an operating system, a component of a monitor, or its functionality may be shared by a plurality of components. Analogously, while hardware access detector 132 is shown included in processor 104, a separate hardware component may be employed or no additional hardware functionality for detecting access to monitored memory locations of addressable entities may be needed, as will be discussed further below in connection with alternate embodiments.

The monitoring of the memory location during runtime can include detection of an access to a monitored memory location and a determination as to the particular addressable entity associated with the memory location. The detection of an access to a monitored memory location may be performed, for example, by detecting all memory accesses and comparing the address of each access against a list of monitored memory addresses held by a table in hardware and/or software. The determination of the addressable entity associated with the memory location of a detected access may be performed, for example, through the use of a memory map of the executable program component 110 and/or monitored addressable entity 112. The tools used to generate a loadable object program component are capable of generating initial memory map information, as is well-known to software developers. The memory map is made usable by a loader 128 that adds, for example, starting addresses of code, data, stack, and heap segments/spaces. The initial map provides sufficient information to enable an access detector to determine the memory locations associated with each addressable entity in the memory map at load-time. This includes all global and static variables, all constants, all code blocks including functions, object methods, subroutines, labeled instructions, and anonymous code blocks (e.g., in ‘C’ program language all instructions between unnamed matching “{}” symbols such as in a “while” loop are unnamed code blocks with their own scope). As addressable entities are instantiated and destroyed during execution, the map is updated.

For new memory locations allocated from stack space associated with newly instantiated addressable entities, the fact that a stack frame includes or references the return address of an addressable entity that caused its instantiation along with the memory map of the code segment of an executable program component 110 (including the return address) can be used by the memory monitor 134 and/or the access detector(s) 130 132 to determine not only the invoking addressable entity 304 but also the invoked addressable entity 112. Additionally, the address of the invoked addressable entity 112 is contained in an instruction pointer of a processor, which enables the access detector 130 132 using a memory map to determine the invoked addressable entity. This basic information allows the access detector 130 132 to determine memory locations of addressable entities in a stack frame associated with each code block addressable entity.

For new memory locations allocated from executable program component 110 heap space, calls to library/system routines that allocate, free, or otherwise manage an executable program component's associated heap space are detectable via the access detectors 130 132 by detecting access to system heap management routines by the execution environment 102. The stack frame of each heap management routine can be used as described above to determine the code block invoking the heap management routine in the described embodiment. As discussed earlier, a memory map is dynamically maintained by the loader/linker 128 and the access detector 130 132. When, for example, a call to a heap management routine is detected that allocates at least a portion of heap space at the request of the code block of the executable program component 110, information from the memory map of the loadable object file 124, which includes addressable data entity information associated with at least a portion of the code block invoking the heap management routine, can be provided for allowing the access detector 130 132 to associate an addressable entity with an address from the heap space allocated by the heap management routine for storing the addressable entity's content. Thus, the access detector 130 132 can be configured to update the memory map dynamically to include information that associates the newly allocated heap space with a particular addressable entity. The access detector 130 132 associates additional information with the allocated heap space, such as data type and scope information, if provided in the memory map of the loadable object file 124. The additional information that is associated depends on the features of the source language, the source code 114, and the development tools 116 122 used in generating the loadable object file 124 and associated memory map. The access detector 130 132 is enabled to update the memory map of the executable program component when other heap management routines affecting the mapping of an addressable entity to a heap location are detected, such as routines to free and resize previously allocated heap locations.

The above described embodiments detect access to each addressable entity, which is associated with a memory location at load time, and detect access to each addressable entity associated with a memory location dynamically during runtime. Other embodiments described herein are also enabled to detect access to specified addressable entities created and associated with a memory location during runtime, as described below.

Some source code debuggers are capable of detecting access to specified addressable entities and are capable of detecting conditions associated with an access to a specified addressable entity. Source code debuggers, as previously stated, require access to source code associated with a monitored addressable entity. Source code debuggers are also language specific, thus requiring a different debugger for each language associated with a monitored addressable entity on a device. Specification of monitoring information requires language specific knowledge by the user of a source code debugger. Source code debuggers further require a language compiler to insert code into a monitored executable program component enabling the debugger to match machine instructions and data locations to source code instructions and data declarations. Memory requirements for debug compatible executable program components are significantly increased. Performance is typically greatly degraded by the extra instructions. Perhaps most significantly, executable code is typically distributed without source code, thus the use of a source code debugger by users without the associated source code provides little, if any, value.

Returning to FIG. 2, when an access is detected to the memory location in block 204 by memory monitor 134, a determining process is performed in block 206 to detect whether the access violates the runtime constraint associated with the memory location. The determination is made using validation information associated with the memory location. The validation information, for example, may be the specification of the constraint associated with the memory location. The determination may be made prior to an occurrence of a detected access, during a detected access, or after a detected access as will be illustrated in the description of the embodiments that follow. The validation information may exist apart from the source code in an associated file or in comments in the source code file, thus requiring no validating instructions or data in the source code or in a monitored executable program component generated from associated source code.

The system 100 includes means for determining whether an access to the memory location by a machine code instruction of an executable program component violates the runtime constraint using validation information associated with the memory location. The validation information is not included in the executable program component 110 and the determining is not performed by the executable program component 110. For example, the system 100 can include a constraint validator component 138. When the memory monitor 134 receives control as result of an access to a monitored memory location of the addressable entity 112, the constraint validator 138 can be invoked to check for constraint violations. The constraint validator 138 can access validation information associated with the memory location of the addressable entity 112 from a validation information data storage 140. For example, addressable entity 112 may be an instruction with a constraint indicating it can be invoked only between 2:00 AM and 4:00 AM on weekdays. It may be the first instruction of a disk backup operation, for example. The constraint validator 138, using a memory map of the executable program component 110 and validation information associated with the addressable entity 112, can invoke an exception handler specified in the validation information to prevent the access. This is illustrated by message 6′ in FIG. 3, which may be a message to operating system 108 to destroy or halt the first executable program component 110 and/or the second executable program component 302. If a violation is not detected, the memory monitor 134 returns control to the software access detector 130, as illustrated by message 6. The software access detector 130 returns from the interrupt, as illustrated by message 7, to allow the processor 104 to complete processing of the second addressable entity in 304, as illustrated by message 8.

Validation information supported by various embodiments of the system and method described can vary in content, but can be classified into a number of broad categories including: addressable entity type information, including memory size and format; value constraints, including valid ranges or sets of allowed values and/or their converse invalid ranges or sets of values; scope information; naming information; access information, including whether a memory location associated with an addressable entity is readable, writeable, executable, or a combination; and contextual information which defines under what circumstance or in what state validation information including constraint information is applicable. These basic categories can be enhanced by including support for the specification of handlers that are invoked when a violation or even a non-error state is detected that is associated with an access of a memory location of an addressable entity. Additionally, validation information can include logical operator information enabling the specification of states or conditions under which a particular access is valid or violates a constraint.

Example 1 below provides an exemplary XML document conforming to a schema that can be used by the memory monitor 134 and the constraint validator 138. The document provides for validation information to be associated with specific addressable entities and categories or types of addressable entities included in an executable program component 110. The validation information can be language neutral and enables the memory monitor 134 and the constraint validator 138 to associate the addressable entity 112 with an accessed memory location when combined with the memory map information discussed above. This association of the addressable entity 112 with a memory location enables the constraint validator 138 to determine whether the access is associated with a violation of the constraints specified in the validation information. The use of source code 114 is not required, nor is active participation of the associated executable program component 110.

### EXAMPLE 1

```
<pconstraints>
    <executable component>
        <url id=0>file://c/progam files/examples/exec prog
        comp.exe</url>
        <symbol>
            <name>mode</name>
            <read/>
            <write/>
            <initialized>true</initialized>
            <integer>
                <length>2</length>
                <unsigned/>
                <range>1..4</range>
                <on-exit><value>4</value></on-exit>
            </integer>
        </symbol>
        <symbol>
            <name>main</name>
            <execute/>
            <symbol>
                <name>argc</name>
                <read/>
                <input/>
                <integer>
                    <length>2</length>
                    <unsigned/>
                    <range>1</range>
                    <on-error>
                        <message>
                            <fatal/>
                            <content>Syntax: %0</content>
                    </on-error>
                </integer>
            </symbol>
            <instances>1</instances>
        </symbol>
            .
            .
            .
        </symbol>
    </executable component>
</pconstraints>
```

Validation information such as that shown in Example 1 may be generated manually by a user (or administrator), such as a developer of the executable program component 110. A user of the executable program component 110 may create or edit existing validation information using information provided in a memory map, as discussed above. In a preferred embodiment, at least a portion of the validation information associated with an addressable entity 112 is generated as an output of a compiler 116, a linker 122, a loader 128, and/or an interpreter (not shown) of representations of the source code 114 corresponding to the addressable entity 112.

A development tool (not shown) that is enabled to parse a representation of the source code may be used to generate validation information. The development tools associated with a processor-independent programming language may use characteristics of the language including, for example, whether the language supports strong or weak type checking; the data types supported; code block types, such as methods of classes, functions, or subroutines; and support for scope associated with addressable entities. In general, the more rules and structure a language supports, the more validation information a development tool can generate on its own.

Example 1 illustrates a <pconstraints> XML document that contains one or more <executable component>elements each corresponding to an executable program component, such as the executable program component 110 of FIG. 1. Each <executable component> element includes a URI or URL, which identifies a loadable executable program component associated with the executable program component 110. The <executable component> elements in the depicted embodiment further include one or more <symbol> elements. Each <symbol> element represents a specific addressable entity in the executable program component or a category or type of addressable entity in the executable program component. The <symbol> elements may be nested in the depicted embodiment. The nesting corresponds to the scope of each addressable entity represented by a <symbol> element. For a language where all addressable entities have global scope, all <symbol> elements appear in the same level of the document as generated by a development tool and/or by a user. The <symbol> elements include a <name>element identifying an addressable entity or a group or category of substantially identical addressable entities. Type information may be provided identifying the type of an addressable entity specified in a language independent manner. SOAP, for example, allows type information to be associated with entities in a remote procedure call (RPC) in a language neutral manner using an analogous XML schema. In fact, the SOAP schema and namespace may be used in an embodiment of a format for specifying validation information. Resource description framework (RDF) may also be used for supporting a schema for generating and processing validation information. Example 1 illustrates other exemplary elements that can be supported, but the example elements are far from being exhaustive.

In Example 1, three addressable entities or addressable entity types are identified and associated with validation information, which is associated with the memory location of an identified addressable entity. The elements identified by their <name> elements are “mode”, a global variable; “main”, an executable code block; and “argc”, an input parameter of main. Any of these may be the addressable entity 112 illustrated in FIGS. 1 and 3.

The addressable entity “mode” has a global scope because it appears in the outermost level of the <symbol> hierarchy. It is a variable as indicated by its <read> and <write> elements. It must be initialized prior to its first access as indicated by the <initialized> element. The memory monitor 134 will interpret “mode” as an unsigned integer occupying two bytes of memory. It may only be assigned values from 1 to 4 as indicated by the <range> element. Finally, before the variable is destroyed, it must contain the value four as indicated by its <on-exit> constraint. Monitor and constraint validator embodiments may vary in their use of elements in validation information as context information, constraint information, or both. For example, the information that “mode” is an unsigned, two byte integer cannot be verified by some monitors, and thus it is used as context allowing the monitor to interpret the content of an associated memory location. The <range> and <value> information is treated by almost all monitors as constraint information, so it is passed to an associated constraint validator for a detected access to a corresponding memory location. In a preferred embodiment, when the memory monitor 134 detects validation information that it is not able to recognize, it simply ignores it and continues processing. The memory monitor 134 may generate a message for presentation, logging, sending to another component, and/or transmitting to another device.

The addressable entity “main” is a code block as identified by its <executable> element. It contains one monitored addressable entity, “argc”. An <instances> element indicates that only one instance of “main” may exist per instance of the executable program component. Other addressable entities that may be in main's scope are not monitored, since no validation information is provided. Addressable entity “argc” is a read-write input parameter and an instance variable of “main” of type unsigned integer. Only one valid value is identified, the value “1”. If the value of “argc” is not “1” when “main” is invoked, an error handler identified by the <on-error> element is to be invoked. The error handler is instructed to generate a message using a template included in the <content> element. The generated message is classified as <fatal>.

Exemplary elements depicted in the validation information in Example 1 include elements associated with type, such as the <integer> and <execute> elements. Detailed type information including the size of a memory location may be supported as illustrated. Types may have modifiers as exemplified by the <unsigned> element. Value constraints are exemplified by the <range> element providing a range of valid values a memory location associated with the addressable entity must have. Value constraints may be specified using lists of valid values, regular expressions, and a variety of other well-known representations.

Example 1 also includes some examples of advanced validation information elements. Elements related to constraint checking within a specified context may be specified. For example, the <on-exit> element instructs a monitor and/or constraint validator to use the content only when the addressable entity is destroyed or the executable program component exits. Access constraint information is exemplified by the <read/> and <write/> elements. The <initialized> element indicates whether an addressable entity must be initialized, and may specify value constraints and contextual constraints indicating when initialization must take place or be completed. Example 1 also illustrates support for event handling or violation handlers as illustrated by the <on-exit> element and the <on-error> element, which includes handling information to be performed when a constraint violation has been detected, either prior, during, or after an access of a memory location of an addressable entity.

In another embodiment, logical elements useful in specifying context or conditions under which a particular constraint is validated may be employed. For example, the following structure shows an exemplary <or> element indicating that either an integer or a char is valid in the particular context in which the <or> element is used:

```
<or>
    <integer/>
    <char/>
</or>
```

Elements supporting logical “AND”, “XOR”, and “NOT” can be supported along with grouping elements analogous to the use of parentheses in math expressions. For example, the constraint may specify that if the value is greater than 1000, the constraint should interpret the value in the associated memory location as an unsigned integer made up of two bytes, otherwise the two bytes are to be interpreted as two ASCII characters that must be lower case.

Using the system and method described, a memory monitor 134 and the constraint validator 138 can check for language violations at runtime where general purpose execution environments cannot. For example, a FORTRAN compiler performs type checking at compile time, but there is no type checking at runtime. The assumption is that it's not necessary given the validation of the source by the compiler. However, malicious code can change a compiler-validated executable program component. More commonly, a compiler-validated executable program component may contain “bugs” detectable only a runtime that violate the language constraints enforced at compile time.

Additionally, using the system and method described, validation information may be provided for an executable program component generated using a loosely typed programming language where the validation information enforces strong type checking at runtime. A language supporting loose or no type checking can be used to generate an executable where strong type checking is enforced by the memory monitor 134 and the constraint validator 138 independent of the language. The memory monitor 134 and the constraint validator 138 using validation information can change the runtime characteristics of the executable program component 110 by providing features not supported by the associated programming language and/or overriding features of the associated programming language. Accordingly, programmers can focus on what the executable program component 110 is supposed to do rather than on the characteristics of the language used or on adding validating and constraint checking code. As a result, software should require fewer lines of source code 114 resulting in a smaller executable program component 110 with fewer bugs. Additionally, the system and method described can allow a user to change the execution environment 102 of an executable program component 110, in effect modifying the behavior of the executable program component 110 without requiring use of the associated source code 114. In some cases, bugs in the executable program component 110 may be detected and an appropriate handler can be invoked to recover from the bug and the running executable program component 110 can be allowed to continue. Moreover, the executable program component 110 developer can distribute bug fixes simply by distributing validation information as a “patch”.

A compiler, preprocessor, or other development tool can be configured to identify all addressable entities 112, 304 in the source code 114 from which an executable program component 110, 302 is generated. In addition, the development tool can, through the type support of the programming language, determine a type, which the constraint validator 138 may use during validation. Development tools that generate the executable program component 110 from the source code 114 can use the same information used to determine memory map information to generate initial validation information for all addressable entities. While most development tools can check type information, range constraints, etc., at compile-, link-, and/or load-time; the execution environments 102 of most executable program components 110, 302 are not capable of enforcing most language constraints during runtime. Those environments that are able to enforce compile-time, link-time, and load-time constraints during execution are language specific execution environments provided by certain interpreter, virtual machines, and source code debuggers, which are not widely usable.

While development tools supporting a strongly typed, highly structured language may generate files with a great deal of validation information, development tools for a language that supports weak or no typing, no scope rules, and has few constraints, may do little more than identify a portion of the addressable entities 112, 304 in an executable program component 110, 302.

A user or administrator may directly edit the generated validation information or edit the validation information through an administrator/user GUI 142 shown in FIG. 1. For strongly typed, highly structured languages, constraints may be validated during run-time in addition to being validated during build-time by the associated tools. Validation information may be tightened, for example, by restricting the range of valid values for a variable not provided for in the source language or in the instructions of the source. The executable program component 110 does not have to be regenerated. In fact, the user changing the validation information does not require the source code 114 in order to modify the validation information. In a typical scenario, a developer may run an executable program component 110 with constraints more severe than those provided by the source language in a supporting execution environment 102. When the executable program component 110 is thoroughly tested, the executable program component 110 may be provided with validation information for enforcing constraints associated with one or more key addressable entities 112, with the remainder of the information dropped. Since changes to the validation information do not require changes to the source code 114 or the associated executable program component, any user may modify the validation information during the life of the program without access to the source code 114.

System 300, through the validation information generated from the various representations of the source code 114 in generating an associated executable, is able to monitor a memory location associated with the addressable entity 112 included in at least a portion of the executable program component 110 by checking constraints for any addressable entity written in any processor independent programming language when language neutral validation information is provided.

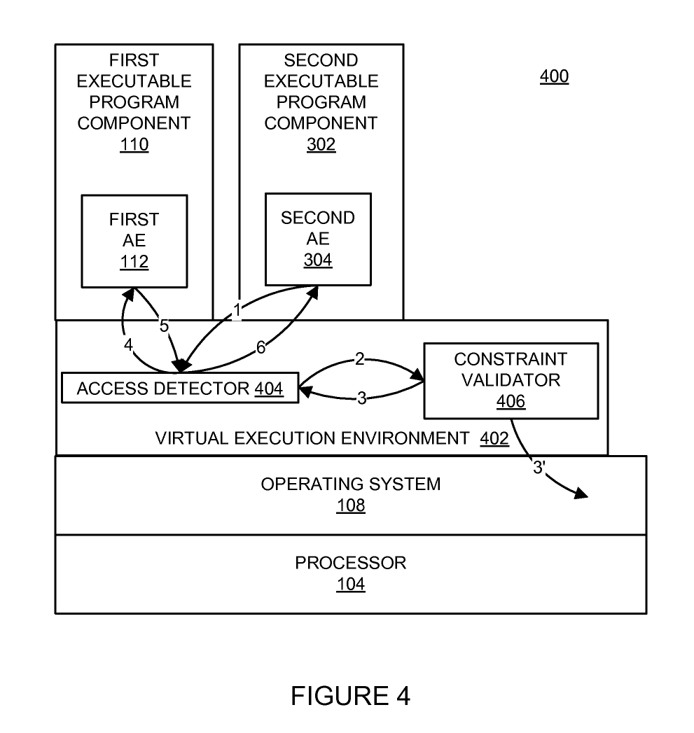

FIG. 4 illustrates a system 400 similar to system 300 in FIG. 3, including the processor 104, the operating system 108, the first executable program component 110, the monitored memory location associated with the first addressable entity 112, the second executable program component 302, and the second addressable entity 304 for instructing processor 104 to access the memory location associated with first addressable entity 112. Other components shown in system 100, such as memory 106, are not shown in FIGS. 3 and 4 but their presence may be assumed as would be appreciated by one of ordinary skill in this art.

System 400 differs from system 300 in that the software access monitor 130 and the hardware access monitor 132 are replaced with an access monitor 404 included in a virtual execution environment 402. Virtual execution environments are well-known and include virtual environments that emulate hardware environments for allowing, for example, a processor specific operating system or other processor specific executable to run on an unsupported processor; or enabling one operating system to be hosted by another operating system, or to support a language specific environment such as the Java Runtime Environment (JRE) and Smalltalk's runtime environment. U.S. patent application Ser. Nos. 11/428,273, 11/428,280, and 11/428,338, referenced above, describe an operating system hosted language neutral execution environment supporting at least one of a virtual, non-sequential address space and a structured memory. A system supporting both a virtual, non-sequential address space and a structured memory is the preferred embodiment of the system depicted in FIG. 4.

Virtual execution environment 402 provides memory management for at least a portion of addressable entities such as the first addressable entity 112 and optionally the second addressable entity 304 included in the respective executable program components 110, 302, of which any portion operates under the control of the virtual execution environment 402. The virtual execution environment 402 enables instructions using virtual execution environment addresses to access memory locations managed by the virtual execution environment 402 by translating the virtual execution environment 402 addresses to the underlying address space of the host operating system 108 and processor 104, thereby enabling access to the associated memory in the memory 106 (not shown). Access is enabled via a memory management system of operating system 108 and processor 104. As such, the virtual execution environment 402 detects all accesses using addresses from the address space of the virtual execution environment 402. The virtual execution environment 402 includes an access detector 404, which determines whether an access is associated with a memory location associated with a monitored addressable entity 112 managed by the virtual execution environment 402. Additionally, the virtual execution environment 402 includes a constraint validator 406 compatible with virtual execution environment 402 in place of the constraint validator 138 of system 300.

For example, processing of the second addressable entity 304, as hosted by the virtual execution environment 402 using the operating system 108 and the processor 104, causes an access to the memory location of the first addressable entity 112 through virtual execution environment 402 using the virtual execution environment address of the memory location. The access detector 404 determines, using a memory map of the virtual execution environment, virtual memory and validation information associated with first addressable entity 112 using a technique analogous to the memory map techniques described above.

In one embodiment, a virtual execution environment 402 uses features of an SQL DBMS as a structured data memory system (SDSS) as described in U.S. patent application Ser. Nos. 11/428,273, 11/428,280, and 11/428,338, referenced above, where all addressable entities are stored in columns and rows of database tables. SQL database management systems are well-known for their ability to allow controlled access to the data managed by the DBMS and to enforce constraints specified by validation information provided to a DBMS. Example 2 below illustrates an example of a portion of a loadable object file as described in U.S. patent application Ser. Nos. 11/428,273, 11/428,280, and 11/428,338, referenced above. The example shows instructions used by a loader to create an instance table for firstAddressassableEntity function. As can be seen, the function instance includes a column for a return value, return_value; three columns identifying the invoking code block and return address, caller_at, caller_instance_table, and caller_instance_row; an input parameter, y; and an instance variable, result. The table creation command includes validation information including constraints. For example, y, an input parameter, cannot be null. Also included in Example 2 is a command creating code block table for containing executable code for various functions, methods, and other code block types. Details on code block usage and the relationships of the two table types in Example 2 can be found in U.S. patent application Ser. Nos. 11/428,273, 11/428,280, and 11/428,338, referenced above.

Following table creation, additional constraint commands are shown. The first grant command grants full access to firstAddressableEntity instances to the SYSTEM allowing the execution environment to manage the instance table. The third GRANT commands gives SYSTEM full access to the code block table. The second GRANT command allows an addressable entity, SecondAddressableEntity, in another executable program component, SecondExecutableProgramComponent to read and write data from and to records of firstAddressableEntity table. The fourth GRANT command gives addressable entity, SecondAddressableEntity, in the executable program component, SecondExecutableProgramComponent, execute access to a record in the block table corresponding to the code block associated with the firstAddressableEntity function. The second and fourth GRANT statements allow the secondAddressableEntity to invoke the firstAddressableEntity as a function. Depending on the language and the development tools used, at least a portion of Example 2 may be generated by the development tools. Additionally, at least a portion of Example 2 may be generated or modified by a user or administrator using the administrator/user GUI 142.

### EXAMPLE 2

```
CREATE TABLE firstAddressableEntity (
  ID int PRIMARY KEY,
  return_value varchar(2000),
  caller_at int
  caller_instance_table varchar(40),
  caller_instance_row int,
  result varchar(2000),
  y int NOT NULL,
  CONSTRAINT PK_doit PRIMARY KEY(ID),
  CONSTRAINT result CHECK(not null),
  CONSTRAINT CK_y CHECK(LEN(y) >= 1)
)
CREATE TABLE code_block (
  code_block_ID int,
  code BLOB,
  CONSTRAINT PK_code_block PRIMARY KEY(code_block_id)
)
```

GRANT READ, WRITE, DELETE, INSERT ON firstAddressableEntity TO SYSTEM;
GRANT READ, WRITE ON firstAddressableEntity TO SecondExecutableProgramComponent:SecondAddressableEntity;
GRANT READ, WRITE, EXECUTE, DELETE, INSERT ON code_block TO SYSTEM;
GRANT EXECUTE ON code_block.ID=firstAddressableEntity TO SecondExeutableProgramComponent.SecondAddressEntity;

Systems using an SDSS to support an execution environment don't require a conventional memory map. The SDSS determines the mapping of addressable entities to virtual execution environment/SDSS addresses and associated memory locations. An SDSS requires no data that is not included in a loadable object file compatible with the SDSS to determine which addressable entity a memory location is associated with when at least a portion of an executable program entity is loaded into the execution environment using the SDSS.

Regardless of the embodiment of the virtual execution environment 402 used, the access of the memory location associated with the first addressable entity 112 by the second addressable entity 304 is detected by the virtual execution environment 402, as illustrated by message 1 depicted in FIG. 4. For example, an SQL DBMS-based execution environment can be called by code generated by a compiler in order to access an addressable program entity stored in the memory managed by the DBMS, and is thus detected. Access detector 404 determines whether the access is for a memory location of the monitored addressable entity 112. The first addressable entity 112 is a monitored addressable entity in this example as identified by the validation information provided to the virtual execution environment 402 from the validation information data storage 140 (shown in FIG. 1), for example. The validation information in an SQL DBMS based virtual execution environment can include constraint clauses included in SQL commands in the loadable object file generated by associated development tools, such as those described in U.S. patent application Ser. Nos. 11/428,273, 11/428,280, and 11/428,338, referenced above. As a result, the access detector 404 signals constraint validator 406 to check for constraint violations as illustrated by message 2. In the exemplary SQL DBMS based virtual execution environment, the constraint validator 406 is the DBMS constraint enforcing mechanism well-known to SQL developers and database administrators. If the constraint validator 406 detects a violation, a violation handler, which is typically specified in the validation information, is invoked as illustrated by message 3′. Alternately or additionally, some constraint validator 406 embodiments may provide default violation handlers, as is the case with a typical SQL DBMS. If no violation is detected, the access is allowed as illustrated by messages 3 and 4. In the exemplary DBMS-based virtual execution environment 402, the execution environment associated with the virtual execution environment 402 provides access via a register or by mapping a virtual execution environment address to an address of the underlying address space of the operating system and/or processor. Finally, control and data, if the access is a read access, is returned to the accessing entity, which is the second addressable entity 304 in FIG. 4. This return of control is illustrated by messages 5 and 6. While not shown explicitly, processing associated with message 1 through 6, including message 3′, can be carried out within the host execution environment provided by the operating system 108 and the processor 104.

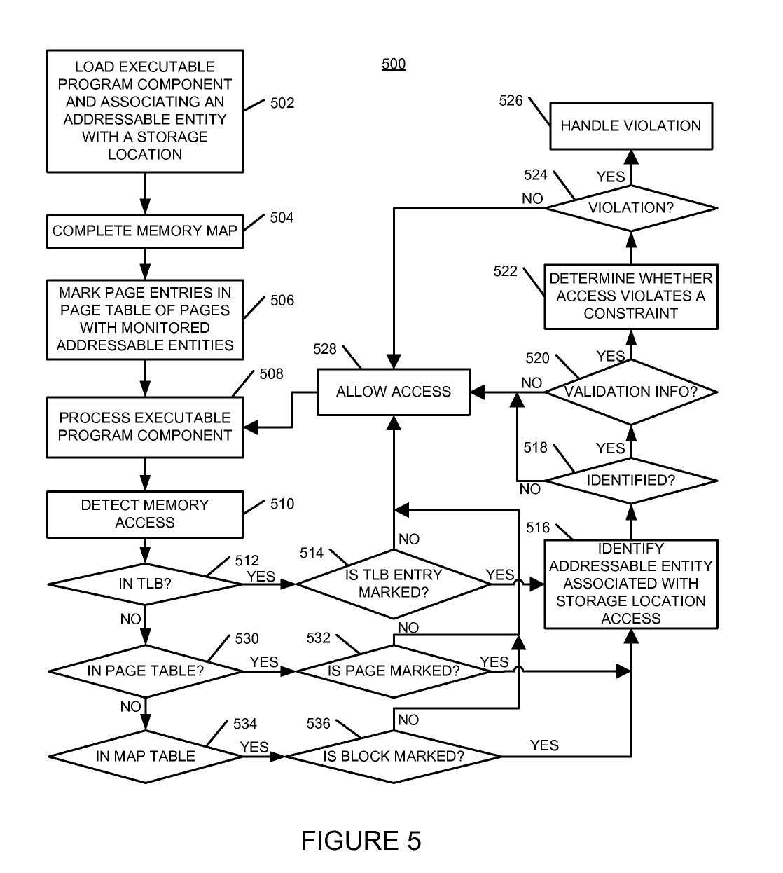

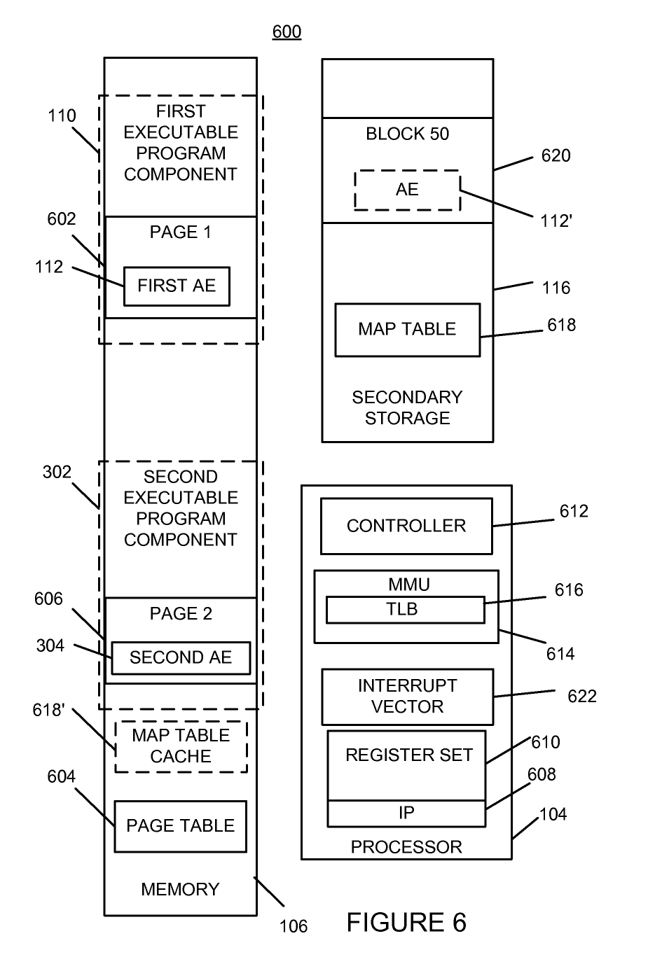

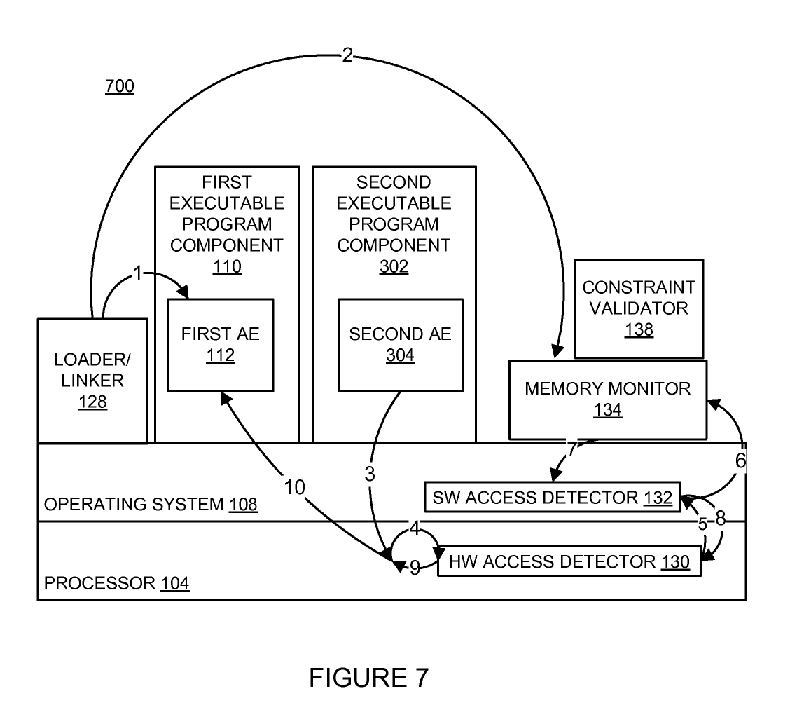

FIG. 5 is a flow chart illustrating a method 500 consistent with the method 200 in FIG. 2 and associated with the memory management system embodiment described herein. The system 600 in FIG. 6 illustrates subsystems and components configured for carrying out at least a portion of method 500, and the system 700 illustrated in FIG. 7 corresponds to a view of an embodiment of the system and method described using method 500 and the subsystems of system 600.

In block 502, an executable program component 110 is loaded into the memory 106, which includes associating an addressable entity 112 included in the executable program component 110 with a memory location. The system 600 includes a memory 106, which may be a virtual, a physical memory or a combination of both, with an address space compatible with the processor 104. The first executable program component 110 with the first addressable entity 112 is loaded into the memory 106. The executable program component 110 may span one or more pages of a supported paged memory system. The first addressable entity 112 is included in page 1 602, as illustrated in FIG. 6. In FIG. 7, the loading into memory of executable program component 110 corresponds to message 1 in which loader/linker 128 and/or operating system 108 initiate the executable program component 110 in preparation for processing of the executable program component 110.

In block 504, a memory map including at least information associated with the monitored first addressable entity 112 is created or completed from an incomplete map generated by build tools used in generating first executable program component 110. For example, in system 600, as the first executable program component 110 is loaded into the memory 106 by the loader 128, the loader 128 may create or complete an existing memory map using at least address information associated with the first addressable entity 112. The memory map is made available to the memory monitor 134 and/or at least one of the access detectors 130 and 132. This process of providing the memory monitor 134 with memory map information is illustrated by message 2 in FIG. 7.

In block 506, entries in a system page table 604 are marked if the associated memory page includes a monitored addressable entity. In system 600, the loader marks the page entry in page table 604 for page 1 602. Alternately, the marking may be done by another component, such as a memory management system. In an embodiment supporting a memory space that spans both processor physical memory (not shown) and physical secondary storage 116, as described in U.S. patent application Ser. Nos. 11/428,273, 11/428,280, and 11/428,338, referenced above, at least a portion of the memory may be stored in physical secondary storage 116. The mapping of a virtual address to the physical secondary storage 116 is enabled by the map table 618, of which a portion may be stored in processor physical memory, as represented by the map table cache 618′. Entries in map table 618 and/or map table cache 618′ can be marked. Alternatively, the blocks in the physical secondary storage 116 including memory areas associated with monitored addressable entities can be marked. For example, a copy of the addressable entity 112, depicted as addressable entity 112′, can be stored in block 50 620 of the secondary storage 116 and may be marked or its entry in the map table 618 and/or the map table cache 618′ may be marked.

In block 508, processing of a loaded executable program component is started or resumed. In system 600, a first instruction of the first executable program component 110 is loaded into the instruction pointer (IP) 608 of the processor 104 and processed by microcode in the controller 612. The first instruction may include an operand referencing a register in a register set 610 of the processor 104 and/or may access a location in the memory 106 using an associated memory management system including a memory management unit 614 with a translation lookaside buffer (TLB) 616, a page table 604, and/or a map table 618 and corresponding cache 618′, in embodiments supporting an address space that spans both physical memory (not shown) and secondary storage 116. Alternately, the instruction may be an instruction from the second executable program component 302 with an operand corresponding to the address of the memory location of the first addressable entity 112, as illustrated by message 3 in FIG. 7.

In block 510, a memory access is detected. In system 600, an access is detected when the content of the memory location is referenced by a memory address in the instruction pointer (IP) 608 or by a processing of an instruction by the controller 612 with an operand value processed as a memory address. For example, memory access can be detected by the controller 612 processing an instruction of the second addressable entity 304, where the instruction includes an operand with a value corresponding to an address of the first addressable entity 112, thus causing processor 104 to initiate a process that accesses the first addressable entity 112.

In block 512, the detected memory access causes a memory management unit to check for a record in the TLB 616 corresponding to the memory address, as is illustrated by message 4 in FIG. 7. If a corresponding entry is included in the TLB 616, a determination is made as to whether the entry is marked for monitoring in block 514. For example, in system 600, a machine code instruction of the second addressable entity 304 having a memory address corresponding to a memory location of the first addressable entity 112 and processed by microcode in the controller 612 causes the MMU 614 to check the TLB 616 for an entry corresponding to the memory address. When a corresponding entry in the TLB 616 is found, the MMU 614 detects whether the entry is marked as monitored. A marked entry corresponding to the memory address of the memory location of the first addressable entity 112 causes the processor 104 to generate an interrupt using an interrupt vector 622. In one embodiment, the interrupt vector 622 includes an entry associated with the interrupt that causes execution flow to invoke a software access detector (not shown), which causes a process analogous to the process described above in connection with FIG. 3. Block 514 corresponds to message 5 in FIG. 7 in the case where a marked entry for the memory address associated with first addressable entity 112 is detected.

When a marked entry is detected, control passes to block 516 where the method attempts to identify the addressable entity associated with the accessed memory location. This corresponds to message 5 and in some embodiments may correspond to message 6, since the identifying step can be performed by the software access detector 132 and/or by the memory monitor 134.

If, as determined in block 518, the addressable entity is identified, it is determined in block 520 whether the access is an access to a monitored memory location with associated validation information, as has been described above using validation information read from an XML document and memory map information. If the access is to a monitored memory location such as the memory location of the first addressable entity 112, control passes to block 522 where the memory monitor 134 and the constraint validator 138 determine whether the access attempt is valid, which is illustrated by message 6 in FIG. 7.

When a violation is detected in block 522, control passes to block 526. The violation, as previously described, may be handled based on information provided in the validation information and/or based on the built-in rules of the memory monitor 134, the constraint validator 138, and/or the operating system 108. No message is shown in system 700 corresponding to this outcome.

If no constraint violation is detected, then control is passed from block 524 to block 528, thus allowing the access, which is illustrated by message 7 to software access detector 132 by which control is returned to the processor 104 in returning from the generated interrupt, which is illustrated by message 8 in FIG. 7. The detected entry associated with the memory address used as an operand in the machine code instruction enables hardware access detector 130 to enable the access of the memory location, as illustrated by message 9, and processing of the instruction, as illustrated by message 10 in FIG. 7. In the system 600, the hardware access detector 132 is embodied at least in part by the MMU 614, the TLB 616, the controller 612, and the interrupt vector 622. When the generated interrupt returns and access has been allowed, the MMU 614 provides information from the TLB 616 entry for enabling the controller 612 to process the instruction, which includes the access to the memory location of the first addressable entity 112 as indicated by the operation code of the machine code instruction and the operands of the instruction, including the memory address of the memory location of addressable entity 112, thus completing block 528. This results in a return of control to block 508, where processing continues with the next instruction.

Returning to block 512, when an entry associated with the memory address of the detected memory access is not in the TLB 616, control passes to block 530 where a lookup occurs in a page table in an attempt to locate the memory location associated with the memory address associated with the access. When an entry corresponding to a page that includes the memory location identified by the memory address is located in the page table, control is passed to block 532. In block 532, a process determines whether the entry or the page associated with the entry is marked indicating the presence of a monitored memory location in the page. When it is determined that the entry or the page itself is marked, control is passed to block 516. In the system 600, corresponding with block 530, when an entry associated with the memory location of the first addressable entity 112 is not found, a lookup occurs using the page table 604 to locate an entry associated with the memory address used as an operand in the machine code instruction being processed by the processor 104. A page table lookup may be performed by a memory management system portion depicted in the system 600. When an entry is found, a determination is made, corresponding to block 532, as to whether one of the entry in page table 604 is marked and the associated page 1 602 is marked. This processing corresponds to detection of a marked page, which may be performed by an MMS, the software access detector 132, which may be part of an MMS, and/or by the memory monitor 134. In either case, the described processing is illustrated by message 6 in FIG. 7.

As previously described, processing associated with block 516 determines whether the memory location identified by the memory address is monitored. In one embodiment, this determination is made using validation information, which identifies at least one addressable entity to be monitored, or a category or type of addressable entity to be monitored. Alternatively, an SDSS backed memory management system can be used to determine whether the memory location is monitored, as described above. The remainder of the method proceeds on from block 516 as previously described.

Returning to block 530, in conventional memory management systems, if a page is not located in a page table, it is an error. The page table contains all pages within a processor accessible memory whether they are currently mapped to physical memory or stored in a swap file, for example. As described in U.S. patent application Ser. Nos. 11/428,273, 11/428,280, and 11/428,338, referenced above, a system and method having a host execution environment for providing a processor address space can be used that spans both physical memory and physical secondary memory. This, for example, enables the contents of portions or all of a virtual address space to survive a reboot of the system where the virtual addresses of the persistent portions of processor address spaces remain associated with the addressable entities through the reboot process. From another perspective, the system allows an addressable entity that is loaded into process address space to remain loaded through a system reboot. In one embodiment of such a method, a map table 618 is used to manage the mapping of processor virtual memory, which is mapped to the secondary storage 116.

In this embodiment, when a page is not located in the page table in block 530, control is passed to block 534 rather than causing an error condition as in a conventional system. A process associated with block 534 locates the page in the map table 618, which identifies a physical memory location in secondary storage 116 associated with the virtual memory location of the addressable entity 112′ to be accessed. When the entry is located, a determination is made as to whether the map table entry or the associated physical memory is marked. If either is marked, control passes to block 516 and proceeds as previously described. In the system 600, if a page table entry is not located a lookup operation is performed using first the map table cache 618′, and then the map table 618 if an entry is not located in the cache 618′. When an entry is located, control is passed to block 516 where processing occurs as described above. It is an error, at this point in processing, if an entry is not located in the map table 618 or the cache 618′. This processing corresponds to message 6 in system 700.

If no marked address is located in the TLB 616, the page table 604, or the map table 618, the memory location associated with the memory address of the machine code instruction is not monitored and control is passed to block 528 to continue execution, thereby allowing access to the memory location of the addressable entity. In system 600, the memory location is accessed according to the operation of the microcode in the controller 612 and processed. Messages 9 and 10 in FIG. 7 illustrate this process.

The following portion of a validation information document depicted in Example 3 illustrates how validation information can be used to enforce a license key requirement in order to operate the associated software. Notice, no code has to be put in the executable to support this other than mechanism for receiving a key and storing it in a monitored variable.

### EXAMPLE 3

```
<pconstraints>
  <executable component>
    <url id=0>file://c/progam files/examples/fpce.exe</url>
      .
      .
      .
    <symbol>
      <name>_main</name>
      .
      .
      .
      <symbol>
        <name>license-key</name>
        <read/><write/>
        <array>
          <length>24</length>
          <char>
          <initialized>false</initialized>
          <on-read><after-write>
            <format>a regular expression</format>
            <on-error>
              <message>
                <fatal/>
                <content>Use of %0 requires a license</content>
              </message>
            </on-error>
          </after-write></on-read>
        </array>
      </symbol>
      .
      .
      .
    </symbol>
  </executable component>
</pconstraints>
```

Example 3 illustrates a <pconstraints> XML document that contains one or more <executable component> elements each corresponding to an executable program component, such as the executable program component 110 of FIG. 1 as previously described with respect to Example 1. The <executable component> element includes a URI or URL, which identifies a loadable executable program component associated with the executable program component 110, as previously described. The <executable component> elements in the depicted embodiment further include one or more <symbol> elements also described earlier. The <symbol> element depicted in Example 3 illustrates a method for enforcing a license key required for allowing execution of executable program component 110. This is provided through the <symbol> element with the <name>, “license-key”. An addressable entity associated with this may be read and/or written to as indicated by the <read/> and <write/> elements. The addressable entity corresponding to the license-key symbol has an array structure as indicated by the <array> element with 24 elements indicated by a <length> element. The type of each array element is “char” indicated by the <char> element. Thus, the license-key is a character string of length 24. For typed languages such as “C”, all of this information is available to a compiler, which allows this validation information to be generated automatically.

The <on-read> and <after-write> elements indicate that constraint checking should occur before a read operation associated with a memory location associated with a license-key addressable entity, and after a write operation. The <initialized> element indicates the addressable entity may be initialized at executable program component start time. Further constraint information indicates that the format of a string in a license-key addressable entity must match a regular expression provided with a <format> element as indicated by the words, “a regular expression”. In a working example, an actual regular expression would replace the words “a regular expression” depicted in Example 3. Example 3 also specifies an error handle. If the <format> constraint is not met. Note that the <initialized>element indicates the first read access of a license-key addressable entity is not subject to the <on-read> constraint specified, but all subsequent read accesses and all write accesses require that the constraint specified is met, otherwise the specified error handler is invoked as specified in the <on-error> element. When a constraint violation is detected, the error handler generates a message as indicated by the <message> element which is marked as a fatal error as indicated by the <fatal/> element. The message generated is based on a template contained in the <content> element where a “% 0” is defined as a place holder for the name of the associated application or executable program components. For example, argv[0] can be the referenced name of the executable program component in a “C” language program.

It should be understood that the various components illustrated in the figures represent logical components that are configured to perform the functionality described herein and may be implemented in software, hardware, or a combination of the two. Moreover, some or all of these logical components may be combined and some may be omitted altogether while still achieving the functionality described herein.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for providing program runtime data validation, comprising:
associating a memory location of an addressable entity with a runtime constraint for the addressable entity, wherein the addressable entity is included in an executable program component generated from source code written in a processor-independent programming language;
monitoring the memory location during runtime; and
determining whether an access to the memory location by a machine code instruction of an executable program component violates the runtime constraint using validation information associated with the memory location, wherein the validation information is not included in the executable program component and the determining is not performed by the executable program component.

2. The method of claim 1 wherein the memory location of the addressable entity is managed by a structured data storage system.

3. The method of claim 2 wherein the structured data storage system is a database management system (DBMS).

4. The method of claim 1 wherein the runtime constraint is specified in a format conforming to at least one of an XML format, a DBMS command language format, and a key word-value format.

5. The method of claim 1 wherein the runtime constraint includes at least one of a value constraint, a scope constraint, a relationship constraint, a conditional constraint, a type constraint, an initialization constraint, a termination constraint, a storage constraint, a parameter constraint, a return value constraint, an instance constraint, and a global constraint.

6. The method of claim 1 wherein at least a portion of the validation information is generated in connection with at least one of parsing, compiling, linking, loading, and interpreting the source code.

7. The method of claim 1 wherein at least a portion of the validation information is created or modified during execution of the executable program component.

8. The method of claim 1 wherein the validation information includes at least one of an event specification, an error handler, a logical expression, and a conditional expression.

9. The method of claim 1 wherein the constraint information includes relationship information relating the addressable entity to another addressable entity.

10. The method of claim 1 wherein the validation information is language neutral.

11. The method of claim 1 comprising providing a user interface configured for enabling a user to create, edit, or delete some or all of the validation information.

12. The method of claim 1 wherein the addressable entity is written in a language that does not support run-time data validation.

13. A system for providing program runtime data validation, comprising:
means for associating a memory location of an addressable entity with a runtime constraint for the addressable entity, wherein the addressable entity is included in an executable program component generated from source code written in a processor-independent programming language;
means for monitoring the memory location during runtime; and
means for determining whether an access to the memory location by a machine code instruction of an executable program component violates the runtime constraint using validation information associated with the memory location, wherein the validation information is not included in the executable program component and the determining is not performed by the executable program component.

14. A system for providing program runtime data validation, comprising:
a loader component configured for associating a memory location of an addressable entity with a runtime constraint for the addressable entity, wherein the addressable entity is included in an executable program component generated from source code written in a processor-independent programming language;
a memory monitor component configured for monitoring the memory location during runtime; and
a constraint validator component configured for determining whether an access to the memory location by a machine code instruction of an executable program component violates the runtime constraint using validation information associated with the memory location, wherein the validation information is not included in the executable program component and the determining is not performed by the executable program component.

15. The system of claim 14 wherein the memory monitor component includes at least one of a software access detector and a hardware access detector.

16. The system of claim 15 wherein the hardware access detector is configured to monitor the memory location during runtime by accessing a memory management unit including a translation lookaside buffer to mark the monitored memory location.

17. The system of claim 15 wherein the hardware access detector is configured to monitor the memory location during runtime by accessing page table to mark the monitored memory location.

18. The system of claim 15 wherein the hardware access detector is configured to monitor the memory location during runtime by accessing map table to mark the monitored memory location.

19. The system of claim 14 wherein the memory monitor component includes a database of addresses of monitored memory locations.

20. The system of claim 19 wherein the memory monitor component is configured to determine the addresses of monitored memory locations using a memory map.

21. The system of claim 20 wherein the memory map is generated by at least one of a compiler, a linker, an interpreter, and a loader.

22. The system of claim 20 wherein the memory monitor component is configured to determine the addresses of monitored memory locations dynamically as the memory map is updated as addressable instances are created and deleted.

23. The system of claim 14 wherein the monitoring component is configured to identify whether an accessed memory location is associated with a monitored addressable entity using a combination of a memory map, validation information, and thread/process context information.

24. The system of claim 14 wherein the constraint validator component is configured to determine whether an access to the memory location by a machine code instruction of an executable program component violates the runtime constraint prior to or during the access to the memory location.

25. The system of claim 14 wherein the constraint validator component is configured to determine whether an access to the memory location by a machine code instruction of an executable program component violates the runtime constraint after the access to the memory location.

26. The system of claim 14 wherein the constraint validator component is configured to invoke an error handler when an access to the memory location by a machine code instruction of an executable program component violates the runtime constraint.

27. The system of claim 26 wherein the error handler is specified by at least one of the validation information and an execution environment.

28. The system of claim 14 wherein a memory address associated with the monitored memory location is from a non-sequential address space.

29. A computer readable medium including a computer program, executable by a machine, for providing program runtime data validation, the computer program comprising executable instructions for:
associating a memory location of an addressable entity with a runtime constraint for the addressable entity, wherein the addressable entity is included in an executable program component generated from source code written in a processor-independent programming language;
monitoring the memory location during runtime; and
determining whether an access to the memory location by a machine code instruction of an executable program component violates the runtime constraint using validation information associated with the memory location, wherein the validation information is not included in the executable program component and the determining is not performed by the executable program component.
